(19) United States
(12) Patent Application Publication
(10) Pub. No.: US 2007/0050229 A1
(43) Pub. Date: Mar. 1, 2007

(54) Methods and systems for providing access to decision critical information for food services supply chain management

(76) Inventors: Edward Tatro, Stamford, CT (US); James A. Carson, Greenwich, CT (US); Tom Heide, Stamford, CT (US)

Correspondence Address: Lipsitz & McAllister, LLC, 755 MAIN STREET, MONROE, CT, 06468, US

(21) Appl. No.: 11/505,794

(22) Filed: Aug. 16, 2006

Related U.S. Application Data
(60) Provisional application No. 60/709,359, filed on Aug. 17, 2005.

(51) Int. Cl. G06F 9/46

(52) U.S. Cl. 705/9

(57) ABSTRACT

Methods, systems, and apparatus for providing access to decision critical information for food services supply chain management are provided in accordance with the present invention. A food services customer can input menu item information into at least one customer database for one or more food services locations. At least one supplier database is provided, each of the at least one supplier database containing information relating to food service supplies offered by a respective supplier. Access to the at least one customer database and the at least one supplier database is controlled via a common access portal. The customer is provided with access to the databases via the portal. The customer can generate a request relating to selected menu items. Information is then provided to the customer from one of (i) the at least one customer database and (ii) the at least one supplier database in response to the request.

This application claims the benefit of U.S. provisional patent application No. 60/709,359 filed on Aug. 17, 2005, which is incorporated herein by reference for all purposes as if fully set for herein.

### BACKGROUND OF THE INVENTION

The present invention relates to methods, apparatus and systems for providing access to decision critical information for food services supply chain management. In particular, the present invention relates to a web hosted full outsourcing service providing Internet based food, beverage and supply ordering. Customers are electronically linked to their suppliers. All procurement, delivery, receiving and adjustments are processed electronically. Integrated inventory management and accounting systems including data warehouse to support sales, operating costs, margin trends and competitive market analysis. All customers have access to the latest up to date suite of systems.

The food service/hospitality industry is now a $120 billion a year industry. Approximately 38 percent of meals are prepared outside of the home. A mid-sized restaurant typically processes 2,000 paper invoices a month. This is inherent in the nature of the industry—a relatively short order cycle (48 hours) for most perishable items leads to frequent ordering and re-ordering of such items. As the food service industry, and particularly the supply chain management side of the food service industry, is labor and paper intensive, substantial cost savings are possible from automating labor-intensive back office operations and other routine operations carried out in the food services industry. In addition, pressure on operating margins will likely increase to realize the traditional eight percent bottom line margin return on investment (beverages typically offer 70 a percent margin). However, the declining use of alcohol is pressuring margins.

It would be advantageous to provide business processes that are a unique application of e-commerce management software tools for the food service industry. It would be further advantageous to provide methods and systems for food service supply chain management meeting industry specific requirements and being designed to carry out critical transaction functions without requiring industry suppliers to modify their existing systems or significantly realign their business practices. In addition, it would also be advantageous to eliminate paper intensive inventory and related manual financial record keeping while significantly improving operating control and profitability in the food services environment.

The methods, apparatus, and systems of the present invention provide the foregoing and other advantages.

### SUMMARY OF THE INVENTION

The present invention relates to methods, apparatus and systems for providing access to decision critical information for food services supply chain management.

In an example embodiment of the present invention, a computerized method for providing access to decision critical information for food services supply chain management is provided. In such an example embodiment, a food services customer is enabled to input menu items information into at least one customer database for one or more food services locations. At least one Supplier database is provided, each of the at least one supplier database containing information relating to food service supplies offered by a respective supplier. Access to the at least one customer database and the at least one supplier database is controlled via a common access portal. The customer is provided with access to the at least one customer database and the at least one supplier database via the common access portal. The customer is enabled to generate a request relating to one or more of the menu items selected from the at least one customer database. Information is then provided to the customer from one of (i) the at least one customer database and (ii) the at least one supplier database in response to the request.

The customer may be enabled to place an order for food services supplies for the one or more of the menu items from the at least one supplier. The customer may own, operate, or manage multiple food services locations. In such a situation, the order placed by the customer may comprises an order for one or more of the multiple food services locations.

In an example embodiment where the customer owns, operates, or manages multiple food services locations, the request for information may comprise a request relating to one or more of the multiple food services locations.

The request may comprise a request for at least one of recipe ingredient pricing for the one or more menu items, availability information, historical ordering information, shipping and receiving information, supplier information, order status information, market pricing information, historical pricing information, historical usage information, trend forecasting information, and the like.

The menu item information may be input using configurable input forms.

The information may be provided to the customer in response to the request in real time or near real time.

Information for multiple food services locations owned, operated, or managed by the same customer may be input into and stored at a single customer database. Alternatively, information for each food services location owned, operated, or managed by the same customer may be input into and stored at a separate customer database. Such separate customer databases may be linked via a at least one of local area network, a wide area network, a global area network, a telephone network, the Internet, or the like.

In a further example embodiment of the present invention, at least one of the menu item information and recipe item information of the customer may be stored on the at least one customer database. In such an example embodiment, at least one of menu planning and recipe planning may be enabled via at the at least one customer database. The at least one of menu planing and recipe planning may be provided for a single food services location, or for multiple food services locations owned, operated, or managed by the same customer. In addition, in such an example embodiment, food delivery planning may be enabled via the customer database.

In an additional example embodiment of the present invention, the at least one customer database and the at least one supplier database may be provided by a service provider. In such an example embodiment, the request may be processed by the service provider to provide a response with the information to the customer. Further, the common access portal may be provided by the service provider, and access to the at least one customer database and the at least one supplier database via the portal may be controlled by the service provider.

The service provider may communicate the request from the customer to the at least one supplier database for current pricing and supply availability for the selected food service supplies corresponding to the one or more menu items. The pricing and supply availability information may then be communicated to the customer database responding to the request.

The at least one supplier database may be periodically updated with information relating to the food service supplies from the supplier.

The food service supplies may comprise at least one of food supplies and beverage supplies. The at least one of food supplies and beverage supplies may comprise at least one of a food product, a drink product, a menu item selection, a recipe item selection, food ingredients, drink ingredients, ingredients for a particular food product, ingredients for a particular drink product, ingredients for a particular menu item selection, and the like.

The request may comprise a request for at least one of food product pricing, drink product pricing, menu item pricing, recipe item pricing, food ingredients pricing, drink ingredients pricing, ingredients pricing for a particular food product, ingredients pricing for a particular drink product, ingredients pricing for a menu selection, and the like.

A record of the orders placed by the customer may be maintained on at least one of (i) the at least one customer database and (ii) the at least one supplier database.

Physical inventory counts may be entered to the customer database using at least one of a handheld computer, a laptop computer, a personal computer, a personal digital assistant, an Internet appliance, or the like. At least one of the physical inventory counts, current inventory information, and historical inventory information may be stored on the customer database.

In a further example embodiment of the present invention, reports may be generated relating to the food service supplies in response to customer or supplier requests for at least one of current or historical ordering information, usage trends, current or historical inventory information, current or historical purchase order information, order confirmation, pricing information, delivery information, profit margins, operating costs, recipe item costs, menu item costs, local market pricing trends, vendor pricing comparisons based on recent competitors' orders, and the like.

Preferred orders may be stored on at least one of (i) the at least one customer database and (ii) the at least one supplier database for the customer, such that automatic re-submission of the preferred orders at designated time intervals is enabled.

In an additional example embodiment of the present invention, the at least one customer database is integrated with the customer's point of sale system. Information regarding food and beverage sales for the customer may be stored on the at least one customer database. This information may be obtained from the customer's point of sale system, either automatically or at periodic intervals under the control of the customer.

In such an example embodiment, at least one of sales forecasting, inventory management, automatic food service supplies purchasing, trend forecasting, and supplies forecast planing may be enabled. Reports may be generated in response to a request from the customer relating to sales forecasting, inventory management, automatic food service supplies purchasing, trend forecasting, supplies forecast planning, and the like.

The at least one customer database may also be integrated with the customer's accounting system, enabling at least one of vendor bill payment, vendor bill reconciliation, sales tax reporting, banking, credit card reconciliation, accounting accrual maintenance, depreciation maintenance, house charge maintenance, generation of customer statements, financial reporting, financial analysis, and the like.

The at least one supplier may provide (upload) a listing of food service supplies with associated pricing information to the supplier database.

The present invention also encompasses a system for providing access to decision critical information for food services supply chain management. An example embodiment of such a system in accordance with the present invention may include at least one customer database for storing menu item information for one or more food services locations. Such a system may also include means for enabling a food services customer to access the one or more customer database and input the menu item information. At least one supplier database may also be provided as part of such a system, each of the at least one supplier database containing information relating to food service supplies offered by a respective supplier. A common access portal may be provided for controlling access to the at least one customer databases and the at least one supplier database. In addition, such a system may also include means for providing the customer with access to the at least one customer databases and the at least one supplier database via the common access portal and means for enabling the customer to generate a request relating to one or more of the menu items selected from the at least one customer database. Means for providing information to the customer from one of (i) the at least one customer database and (ii) the at least one supplier database in response to the request may also be provided as part of such a system.

The system may be implemented using a network connection such as a local area network (LAN) or a wide area network (WAN) with connectivity either through dedicated or shared services, a LAN and or WAN including internet connectivity, or any combination of networks, including combinations of LAN, WAN, Internet, Extranet, telephone networks, cable networks, including wired or wireless networks, or the like.

The features of the example embodiments of the methods provided in accordance with the present invention discussed above may also be provided by the system embodiments of the present invention.

The present invention provides the following features and advantages, among others:
Collects, weighs and evaluates information related to business material and service costs in the food service industry.
Eliminates significant labor and material costs versus standard paper generated invoicing.
Facilitates electronic communication between restaurants and suppliers enabling real time best price and availability decision making.
Stores and updates all the latest suppliers prices for commodities and other products used by the customer in the food service industry.
Integrates the essential restaurant back office operations of procurement, product delivery, inventory management, menu and recipe and accounting into one seamless easy to use information management system thereby eliminating costly duplication of non-compatible systems and processes.
Provides real time information for inventory management, purchasing, cost management at the line item level; profit management at the menu, recipe and beverage level thereby significantly reducing time, labor costs versus current systems, practices and methods.
Provides item level purchasing requirements as defined by accurate data derived from real time line item inventory knowledge, historical customer demand at the line item level and recipe and beverage use standards resulting in more efficient material purchasing and requirements planning.
Improves purchasing productivity by purchase/order delivery management via the Internet thereby eliminating costly duplication of automated and non-automated systems as well as internal communication systems.
Provides and combines multiple product-sourcing, contract buying and pricing trends into one seamless automated system thereby eliminating paper and labor intensive practices and methods.
Provides real time critical data to improve monthly sales versus plan and identifies operating trends that pinpoint shrinkage, waste, margins, pricing and seasonality versus current business practices and methods.
Provides an Internet link between the restaurant and its suppliers enabling on line pricing, availability, multiple sourcing, contract buying and automated replenishment versus current paper and labor-intensive processes.
Automatically validates supplier invoices for price and delivery variances versus manual (error prone) processes.
Automatically integrates all purchasing transactions into the general ledger/accounting system regardless of what accounting system the customer is using thereby eliminating costly duplicate data entry.
Automatically integrates with the customers Point of Sales system thereby providing accurate sales data that automatically relieves inventory and facilitates purchase requirements, automatic product replenishment and enables materials forecast planning thereby increasing efficiency and accuracy resulting in lower cost of sales.
Centrally hosts the software (as an Application Service Provider while also offering services as a Business Processor Outsourcer) and all the customers data and files in a secured environment thereby providing a safe and complete recovery in the event of a disaster at any or all of the customer's locations.
Enables the customer to improve gross margin, reduce operating costs and labor and improve profit by outsourcing critical back office functions under a fixed service contract.
Provides an extensive on line product and supply catalog by food service industry product code thereby insuring order accuracy and verification.
Provides real time updates for product purchases, receipts/returns, usage and physical inventory adjustments.
Builds and maintains key item level recipe costs, establishes food and beverage usage standards and calculates available food servings.
Provides and improves operating margin management by integration of the Point of Sales system, recipe and inventory data, calculates food/beverage consumption versus target and gross profit by menu/beverage line item.
Calculates and provides gross margin trends and competitive market analysis, comparative supplier prices and trends, physical inventory exception analysis and real time inventory status.
Automatically integrates and records all required accounting transaction which include but are not limited to: vendor bill payment/reconciliation, sales tax reporting, bank and credit card reconciliation, maintain accounting accruals/depreciation, house charge maintenance/customer statements, weekly, monthly, year to date full financial reporting and analysis.

### BRIEF DESCRIPTION OF THE DRAWINGS

The present invention will hereinafter be described in conjunction with the appended drawing figures, wherein like reference numerals denote like elements, and:

FIG. 1 shows a block diagram of an example embodiment of the present invention; and

FIG. 2 shows a block diagram of a further example embodiment of the present invention;

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

Operational costs in the food services industry can be significantly reduced through automation of routine, labor-intensive activities such as food and beverage ordering. With the advent and acceptance of Point of Sale (POS) technology, the food service industry has finally matured enough to reap the benefits of a web-based supply chain management system provided by the present invention.

The present invention provides a turnkey solution suitable for a wide range of users. By partnering with existing “best of breed” suppliers, the present invention offers additional value-added services to restaurants. The present invention integrates business functions and facilitates automation without major outlay by the restaurant. The present invention provides improved inventory control and reduces shrinkage. The present invention further offers significant productivity benefits for the back office, facilitating everything from procurement operations to financial controls. The present invention also leverages the existing investment in a POS system.

The present invention's technical architecture may be based on Microsoft's N-Tier Internet technology. As a three-tier architecture, the application is constructed using ASP.Net, a middle tier layer and Sequel Server 2000 database. ASP.Net can work with any Internet browser and will allow the present invention to scale easily as new customers and suppliers are brought on board. In the ASP.Net environment, the data access page is disconnected from the database as soon as the customer has obtained his data. Business logic resides in the middle-tier layer. This enables hundreds of users to access an Internet site provided by the present invention without impacting system performance while minimizing data base server licensing requirements. Those skilled in the art will appreciate that the present invention may be implemented using a variety of different hardware and software components, of which the foregoing is but one example.

The present invention may provide the following services, among others, to a restaurant owner or manager:
Calculate and update menu requirements
Maintain inventory
Facilitate physical inventory adjustments
Determine food requirements
Identify lowest supplier price and availability
Issues purchase orders (discreet, time released, replenishment, customer pickup)
Record food and beverage receipts
Record receipt adjustments
Reconcile supplier's invoice
Execute approved customer payment
Update accounting records (sales, menu and material costs, financial inventory, accounts payable, general ledger)
Maintain data warehouse for operating trends and competitive market information

The present invention may provide the following services, among others, to a food service supplier:
Maintain Item Price and Availability Catalog
Broadcast promotions/specials
Track all Customer item price and availability information requests
Handle all Customer purchase orders
Create shipping acknowledgement and manifest
Record Customer receipt and returns/adjustments
Create Customer Invoice
Create Customer Credit Memo
Track all EFT and credit card invoice payments
Track open customer purchase orders/back orders/invoices

The present invention supports a large number of business functions, including but not limited to:
Automate price and availability requests to and from suppliers
Automate purchase order as a replacement for telephone and fax
Support special devices such handheld computers/PDAs to improve productivity
Accommodate bid requests for standard products and special requests
Route bid requests to appropriate suppliers
Accommodate standard e-mail interface
Enable operational and financial reporting
Readily interface with external accounting package such as Peachtree/Quick books
Automate receiving and invoice reconciliation
Provide interactive search and display functions
Facilitate the promotion of specials for supplier
Enable provisions for General Ledger account numbers with sub account and cost center
Provide a request for information process
Provide for customization, navigation and eliminate fax
Provide shortcut keys for navigation
Assign and manage standard products (approximately 6000 already currently identified)
Accommodate specialty commodities such as wine
Provide a customer master account accommodating multiple stores with central (headquarters) ordering, enabling one manager to purchase for multiple locations
Accommodate multiple distribution locations for a supplier
Receiving—reconcile order with corresponding PO
Identify receipts by PO
Break out shorts, returns and backorders
Provide catalog class codes and descriptions
Identify quantity on order
Identify backorders outstanding to find alternate supplier
Support credit card processing for payments
Define requirements for new menu items
Set thresholds for monitoring and reordering menu items
Enable reporting—recap daily store sales—import into Peachtree from POS system
Provide peer cost comparisons
Enable migration from paper intensive to electronic mode
Manage volatile/perishable commodities
Support supplemental services such as cleaning, routine equipment maintenance
Provide dropdown box to select adjustment codes
Enable sessions/provisions for active update
Provide low-tech interface to send e-mail with a request for price and availability to one or more potential suppliers
Provide templates to isolate user interface from applications and database
Employ customizable templates to accommodate variations
Provide a menu building function
Maintain return/adjustment codes
Provide standard screen templates to provide consistent format and navigation and simplify maintenance—drop down menus
Provide audit trails—last update timestamp
Provide accounting feeds—export information to appropriate format for Peachtree or comparable package
Enable correspondence between generic catalog item identifier and existing supplier's identifier (none to many relationship)
Provide account store entity, store manager, store/chain identifier
Differentiate taxable and nontaxable items
Automatically generate a purchase order at receiving for any order from a known supplier (exception when pending purchase order is not available)
Automated time release PO for standard replenishment orders suitable for supplies and price/demand stable items
Differentiate commodities by class and subclass—approximately ninety classes identified
Enable creation of an inventory catalog for a supplier that doesn't already have an inventory catalog
Archive, purge and backup
Quote item prices in both portion sizes and shipping units (packer)
Maintain accounting history
Reduce administrative costs
Supply financial operating trend data
Provisions for purchases from petty cash
Treat miscellaneous purchases from wholesalers' like Costco/BJ as a separate class of supplier (customer pickup), generate dummy PO to track purchases.
Adjust unit of measure to accommodate supplier—pour/liter ounces, pounds, bushels
Provide a transaction log with an audit trail of key activities and events which also serves to asynchronously trigger subsequent actions and processes such as status alerts.

Those skilled in the art should appreciate that, while example embodiments of the present invention are described above in connection with restaurants, the present invention is applicable not only to restaurants, but also to the hospitality industry, large institutions (colleges, hospitals, or large companies with their own cafeterias), the catering industry, and the like. Accordingly, in the following description of example embodiments, the term “food services customer” or simply “customer” is used to designate the person or entity that owns, manages, or operates one or more food services location. Similarly, it should be understood that the term “food services location” refers to a restaurant, a hotel, an institution such as a college or large company with its own cafeteria or multiple cafeterias (which may be in one or more geographic locations), a catering business, or the like.

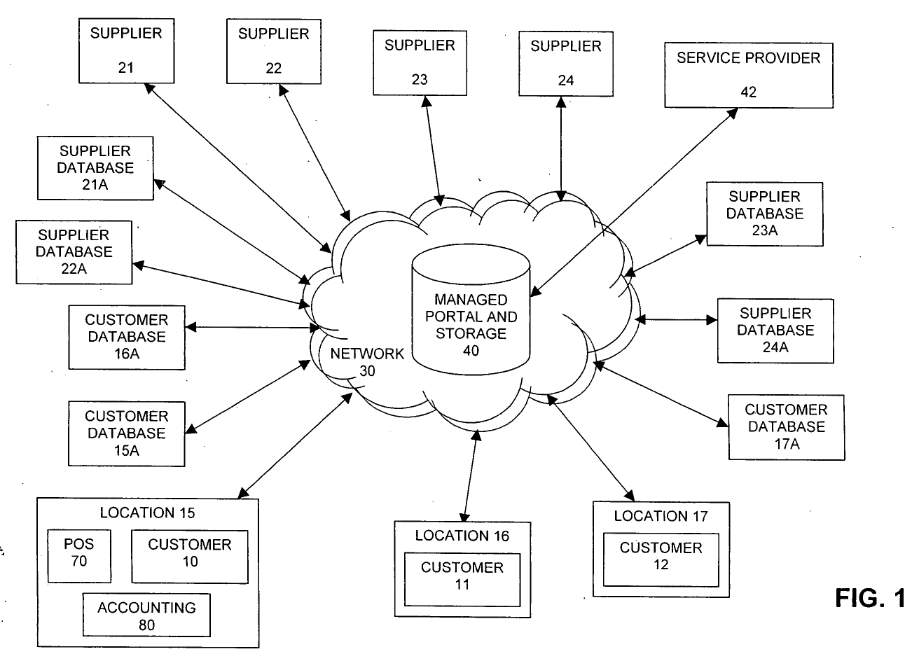

In an example embodiment of the present invention, a computerized method for providing access to decision critical information for food services supply chain management is provided. As shown in FIG. 1, in such an example embodiment, a food services customer is enabled to input menu item information into at least one associated customer database A for one or more food services locations 15. At least one supplier database 21A is provided, each of the at least one supplier database containing information relating to food service supplies offered by a respective supplier 21.

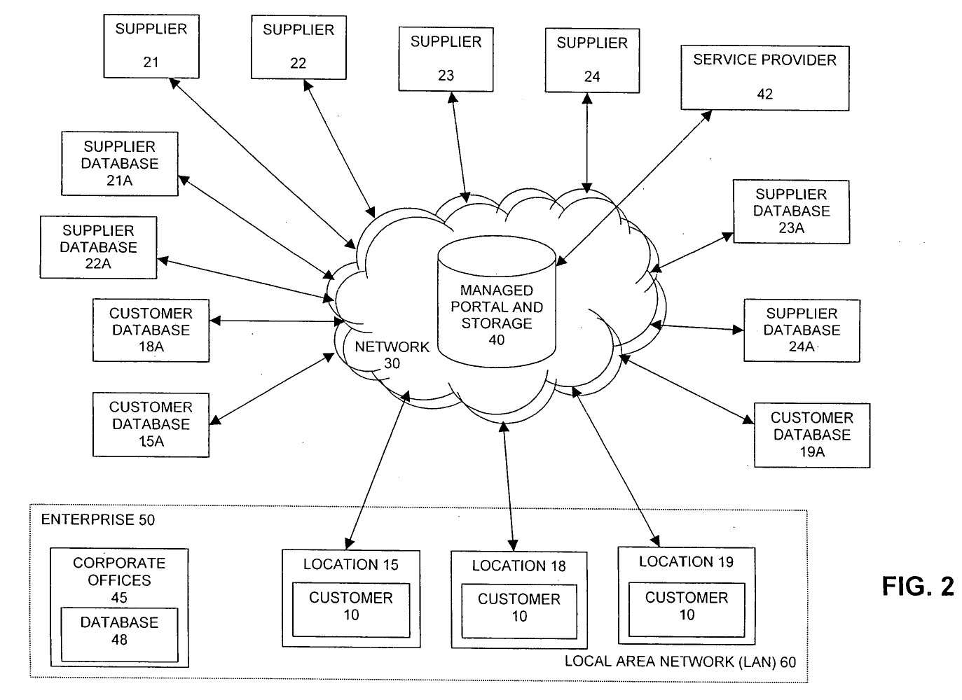

FIG. 1 shows three separate locations 15, 16, and 17, each with an associated food services customer 10, 11, and 12, respectively. Each location 15, 16, and 17 is shown as having an associated customer database 15A, 16A, and 17A, respectively. Four separate suppliers 21, 22, 23, and 24, are shown, each with an associated database 21A, 22A, 23A, and 24A. The present invention is easily scalable and can accommodate a large number of customers, food services locations, suppliers, and databases. As will be discussed in detail below in connection with FIG. 2, each customer 10 may own, operate, or manage one or more foods services locations 15. In such an example embodiment, the same customer 10 may input information into a single database for each location it controls, or into separate databases for each location. In FIG. 1, the customer databases 15A, 16A, and 17A, and the supplier databases 21A, 22A, 23A, and 24A are shown as being distributed throughout network 30. Those skilled in the art will appreciate that an example embodiment of the invention could be implemented with the respective databases (or at least some of the databases) located at the physical location of either the supplier or the customer, or connected to the respective supplier or customer via a local area network, without requiring the customer or supplier to use the common access portal to access its own database.

For ease of explanation, the operation of an example embodiment of present invention will be discussed below in connection with a single customer, customer 10 and the associated customer database 15A.

Access to the at least one customer database 15A and the at least one supplier database 21A, 22A, 23A, and 24A is controlled via a common access portal 40. The customer 10 is provided with access to the at least one customer database 15A and the at least one supplier database 21A, 22A, 23A, and 24A via the common access portal 40. The customer 10 is enabled to generate a request relating to one or more of the menu items selected from the at least one customer database 15A. Information is then provided to the customer 10 from one of (i) the at least one customer database 15A and (ii) the at least one supplier database 21A, 22A, 23A, and 24A in response to the request.

A further example embodiment of the present invention is shown in FIG. 2. In the example embodiment shown in FIG. 2, the same customer 10 owns, operates, or manages multiple food services locations (e.g., locations 15, 18, and 19) with associated databases (e.g., databases 15A, 18A, and 19A). In such an example embodiment, the request for information may comprise a request relating to one or more of the multiple food services locations 15, 18, and/or 19. As shown in FIG. 2, each location controlled by the customer 10 may be part of an enterprise 50 and connected by a local area network (LAN) 60. The enterprise may have a corporate office 45 with an associated database 48. In the example embodiment shown in FIG. 2, the customer 10 may input menu item information for each location 15, 18, and 19 into an associated database for that location (i.e., databases 15A, 18A, and 19A) or into a single database (such as database 48 at the corporate office 45 or any one of the databases 15A, 18A, or 19A). Those skilled in the art should appreciate that although FIG. 2 shows only a single enterprise 50 with multiple locations 15, 18, and 19, the present invention is easily scalable and can accommodate multiple enterprises and their associated locations. Further, those skilled in the art will appreciate that the present invention can accommodate one or more enterprises together with one or more individual locations. In other words, the embodiments shown in FIGS. 1 and 2 can be easily combined to provide services on an enterprise wide basis and an individual store basis.

In the example embodiments shown in FIGS. 1 and 2, the at least one customer database 15A and the at least one supplier database 21A, 22A, 23A, and 24A may be provided by a service provider 42. The service provider may be an application service provider (ASP) which provides and maintains the software used to implement an embodiment of the present invention over network 30. In such an example embodiment, the request may be processed by the service provider 42 to provide a response with the information to the customer 10. Further, the common access portal 40 may be provided by the service provider 42, and access to the at least one customer database 15A and the at least one supplier database 21A, 22A, 23A, and 24A via the portal 40 may be controlled by the service provider 42.

The service provider 42 may communicate the request from the customer 10 to the at least one supplier database 21A, 22A, 23A, and 24A for current pricing and supply availability for the selected food service supplies corresponding to the one or more menu items. The pricing and supply availability information may then be communicated to the customer database 15A responding to the request. The customer 10 can then access the pricing and supply availability information from its database 15A.

The customer 10 may be enabled to place an order for food services supplies for the one or more of the menu items from the at least one supplier 21, 22, 23, and 24A. For example, referring to FIG. 1, the customer 10 may log onto the network 30, which may be, for example, a wide area network (WAN), a telephone network, a global area network such as the internet, or a combination of various types of networks, including local area networks (LANS). The customer may be provided with access to the network 30 by the ASP 42 via a web site. The customer 10 may be provided with secure password protected access to its associated database 15A, for example through a home page provided for the customer 10 via the ASP 42. The customer 10 can then generate the request for information relating to one or more menu items. Ingredient information for each menu item, which was previously input into the customer database 15A, may be automatically obtained from the customer database 15A and included in the request. The request may then be processed by the service provider 42 and sent to the appropriate supplier(s) (e.g., one or more of suppliers 21-24). The supplier(s) that receive the request can obtain the requested information from their associated database(s) (e.g., supplier databases 21A-24A) and return the requested information to the ASP 42. The ASP can then forward the requested information (e.g., pricing and availability information from one or more suppliers) to the customer 10. The customer 10 can review this information and place an order for food services supplies for one or more of the menu items from one or more selected supplier based on the pricing and availability information. The order may processed by the ASP 42 and sent to the one or more selected suppliers 21-24, who then fill the order, arrange for delivery of the food service supplies, and bill the customer.

As discussed above in connection with FIG. 1, the customer 10 may be enabled to place an order for food services supplies for the one or more of the menu items from the at least one supplier 21, 22, 23, and 24. In the example embodiment shown in FIG. 2, the order placed by the customer 10 may comprises an order for one or more of the multiple food services locations 15, 18, and/or 19.

The request generated by the customer 10 may comprise a request for at least one of recipe ingredient pricing for the one or more menu items, availability information, historical ordering information, shipping and receiving information, supplier information, order status information, market pricing information, historical pricing information, historical usage information, trend forecasting information, and the like.

The menu item information may be input by the customer 10 using configurable input forms. The input forms enable the customer 10 to build menu items by inputting recipe level and ingredient level information into the forms, which can then be uploaded to the respective customer database.

The information may be provided to the customer 10 in response to the request in real time or near real time via the network 30.

As discussed above in connection with FIG. 2, information for multiple food services locations owned, operated, or managed by the same customer 10 may be input into and stored at a single customer database (e.g., corporate database 48 or one of customer databases 15A, 18A, or 19A). Alternatively, information for each food services location 15, 18, and 19 owned, operated, or managed by the same customer 10 may be input into and stored at a separate customer database 15A, 18A, and 19A. Although customer databases 15A, 18A, and 19A are shown in FIG. 2 as being outside of the LAN 60 of the enterprise 50, those skilled in the art will appreciate that the databases 15A, 18A, and 19A, as well as corporate database 48, may be linked via the local area network 60 so that access to these databases by the customer 10 is not via the portal 40.

In a further example embodiment of the present invention, at least one of the menu item information and recipe item information of the customer 10 may be stored on the at least one customer database 15A. In such an example embodiment, at least one of menu planning and recipe planning may be enabled via at the at least one customer database 15A. The at least one of menu planing and recipe planning may be provided for a single food services location 15, or for multiple food services locations owned, operated, or managed by the same customer (e.g., locations 15, 18, and 19 as shown in FIG. 2). In addition, in such an example embodiment, food delivery planning may be enabled via the customer database 15A. Further, as shown in FIG. 2, enterprise wide menu, recipe, and food delivery planning may be enabled using one or more of the customer databases 15A, 18A, and 19A and corporate database 48.

The at least one supplier database (e.g., supplier databases 21A-24A) may be periodically updated with information relating to the food service supplies from the respective supplier (e.g., supplier 21-24). Each supplier (e.g., supplier 21) may provide information to at least one associated database (e.g., supplier database 21A). For example, the at least one supplier 21-24 may provide (upload) a listing of food service supplies with associated pricing information to the supplier database. It should be appreciated that a supplier 21 may provide information to more than one database. For example, if a supplier 21 provides two different types of supplies, such as food supplies and beverage supplies, the supplier 21 may choose to provide information relating to the food supplies to one database and information relating to beverage supplies to another database. Although possible, the present invention does not contemplate the situation where more than one supplier 21 provides information to the same database.

The food service supplies may comprise at least one of food supplies and beverage supplies. The at least one of food supplies and beverage supplies may comprise at least one of a food product, a drink product, a menu item selection, a recipe item selection, food ingredients, drink ingredients, ingredients for a particular food product, ingredients for a particular drink product, ingredients for a particular menu item selection, and the like.

Those skilled in the art will appreciate that the supplies provided by the suppliers 21-24 and listed on the associated databases 21A-24A may also include other food service related items and supplies, such as cleaning supplies, kitchen supplies, uniforms, durable goods, paper products such as napkins, paper cups, paper bags, and paper plates, cutlery, cooking utensils, pots, pans, tables, chairs, pizza boxes, doggie bags, and any other conceivable item that may be used in the food service industry.

The request from the customer 10 may comprise a request for at least one of food product pricing, drink product pricing, menu item pricing, recipe item pricing, food ingredients pricing, drink ingredients pricing, ingredients pricing for a particular food product, ingredients pricing for a particular drink product, ingredients pricing for a menu selection, and the like.

A record of the orders placed by the customer 10 may be maintained on at least one of (i) the at least one customer database 15A and (ii) the at least one supplier database 21A-24A.

Physical inventory counts may be entered by the customer 10 to the customer database 15A using at least one of a handheld computer, a laptop computer, a personal computer, a personal digital assistant, an internet appliance, or the like. At least one of the physical inventory counts, current inventory information, and historical inventory information may be stored on the customer database 15A.

In this regard it should be appreciated that the block representing the customers 10, 11, and 12 in the Figures includes the hardware and software necessary for the customer to access the network 30, input information into the databases, generate requests and orders, and obtain information from the network, including but not limited to a handheld computer, a laptop computer, a personal computer, a personal digital assistant, an Internet appliance, or other similar devices capable of communicating information over a network.

In a further example embodiment of the present invention, reports may be generated relating to the food service supplies in response to customer 10 or supplier 21-24 requests for at least one of current or historical ordering information, usage trends, current or historical inventory information, current or historical purchase order information, order confirmation, pricing information, delivery information, profit margins, operating costs, recipe item costs, menu item costs, local market pricing trends, vendor pricing comparisons based on recent competitors'orders, and the like.

Preferred orders may be stored of at least one of (i) the at least one customer database 15A and (ii) the at least one supplier database 21A-24A for the customer 10, such that automatic re-submission of the preferred orders at designated time intervals is enabled.

In an additional example embodiment of the present invention, the at least one customer database 15A is integrated with the customer's point of sale system (POS) 70, as shown in FIG. 1. Information regarding food and beverage sales for the customer 10 may be stored on the at least one customer database 15A. This information may be obtained from the customer's point of sale system 70, either automatically or at periodic intervals under the control of the customer 10.

In such an example embodiment, at least one of sales forecasting, inventory management, automatic food service supplies purchasing, trend forecasting, and supplies forecast planning may be enabled. Reports may be generated in response to a request from the customer 10 relating to sales forecasting, inventory management, automatic food service supplies purchasing, trend forecasting, supplies forecast planning, and the like.

The at least one customer database 15A may also be integrated with the customer's accounting system 80, enabling at least one of vendor (supplier) bill payment, vendor bill reconciliation, sales tax reporting, banking, credit card reconciliation, accounting accrual maintenance, depreciation maintenance, house charge maintenance, generation of customer statements, financial reporting, financial analysis, and the like.

It should now be appreciated that the present invention provides advantageous methods, systems, and apparatus for providing access to decision critical information for food services supply chain management.

Although the invention has been described in connection with various illustrated embodiments, numerous modifications and adaptations may be made thereto without departing from the spirit and scope of the invention as set forth in the claims.

What is claimed is:

1. A computerized method for providing access to decision critical information for food services supply chain management, comprising:
enabling a food services customer to input menu item information into at least one customer database for one or more food services locations;
providing at least one supplier database, each of said at least one supplier database containing information relating to food service supplies offered by a respective supply;
controlling access to said at least one customer database and said at least one supplier database via a common access portal;
providing said customer with access to said at least one customer database and said at least one supplier database via said common access portal;
enabling said customer to generate a request relating to one or more of said menu items selected from said at least one customer database;
providing information to said customer from one of (i) said at least one customer database and (ii) said at least one supplier database in response to said request.

2. A method in accordance with claim 1, further comprising:
enabling said customer to place an order for food services supplies for said one or more of said menu items from said at least one supplier.

3. A method in accordance with claim 2, wherein:
said customer owns, operates, or manages multiple food services locations;
said order comprises an order for one or more of said multiple food services locations.

4. A method in accordance with claim 1, wherein:
said request comprises a request for at least one of recipe ingredient pricing for said one or more menu items, availability information, historical ordering information, shipping and receiving information, supplier information, order status information, market pricing information, historical pricing information, historical usage information, and trend forecasting information.

5. A method in accordance with claim 1, wherein:
said menu item information is input using configurable input forms.

6. A method in accordance with claim 1 wherein:
said information is provided to said customer in response to said request in real time or near real time.

7. A method in accordance with claim 1, wherein:
information for multiple food services locations owned, operated, or managed by said customer is input into and stored at a single customer database.

8. A method in accordance with claim 1, wherein:
information for each food services location owned, operated, or managed by said customer is input into and stored at a separate customer database.

9. A method in accordance with claim 8, wherein:
said separate customer databases are linked via at least one of a local area network, a wide area network, a global area network, a telephone network, or the Internet.

10. A method in accordance with claim 1, wherein:
said customer owns, operates, or manages multiple food services locations; and
said request for information comprises a request relating to one or more of said multiple food services locations.

11. A method in accordance with claim 1, further comprising:
storing alt least one of said menu item information and recipe item information of said customer on said at least one customer database.

12. A method in accordance with claim 11, further comprising:
enabling at least one of menu planning and recipe planning via at said at least one customer database.

13. A method in accordance with claim 12, wherein said at least one of menu planing and recipe planning is provided for a single food services location.

14. A method in accordance with claim 12, wherein said at least one of menu planing and recipe planning is provided for multiple food services locations owned, operated, or managed by said customer.

15. A method in accordance with claim 12, further comprising:
enabling food delivery planning via said customer database.

16. A method in accordance with claim 1, wherein:
said at least one customer database and said at least one supplier database are provided by a service provider;
said request is processed by the service provider to provide a response with said information to said customer.

17. A method in accordance with claim 16, wherein:
said common access portal is provided by the service provider; and
access to said at least one customer database and said at least one supplier database via the portal is controlled by said service provider.

18. A method in accordance with claim 16, further comprising:
communicating by said service provider of said request to said at least one supplier database for current pricing and supply availability for said selected food service supplies corresponding to said one or more menu items; and
enabling communication of said pricing and supply availability information to said customer database responding to said request.

19. A method in accordance with claim 1, further comprising:
periodically updating the at least one supplier database with information relating to said food service supplies from said supplier.

20. A method in accordance with claim 1, wherein:
said food service supplies comprise at least one of food supplies and beverage supplies.

21. A method in accordance with claim 20, wherein:
said at least one of food supplies and beverage supplies comprise at least one of a food product, a drink product, a menu item selection, a recipe item selection, food ingredients, drink ingredients, ingredients for a particular food product, ingredients for a particular drink product, and ingredients for a particular menu item selection.

22. A method in accordance with claim 1, wherein:
said request comprises a request for at least one of food product pricing, drink product pricing, menu item pricing, recipe item pricing, food ingredients pricing, drink ingredients pricing, ingredients pricing for a particular food product, ingredients pricing for a particular drink product, and ingredients pricing for a menu selection.

23. A method in accordance with claim 1, further comprising:
maintaining a record of said orders placed by said customer on at least one of (i) said at least one customer database and (ii) said at least one supplier database.

24. A method in accordance with claim 1, further comprising:
entering physical inventory counts to said customer database using at least one of a handheld computer, a laptop computer, a personal computer, a personal digital assistant and an Internet appliance; and
storing at least one of said physical inventory counts, current inventory information, and historical inventory information on said customer database.

25. A method in accordance with claim 1, further comprising:
generating reports relating to said food service supplies in response to customer or supplier requests for at least one of current or historical ordering information, usage trends, current or historical inventory information, current or historical purchase order information, order confirmation, pricing information, delivery information, profit margins, operating costs, recipe item costs, menu item costs, local market pricing trends, and vendor pricing comparisons based on recent competitors' orders.

26. A method in accordance with claim 1, further comprising:
storing preferred orders on at least one of (i) said at least one customer database and (ii) said at least one supplier database for said customer; and
enabling automatic re-submission of said preferred orders at designated time intervals.

27. A method in accordance with claim 1, further comprising:
integrating said at least one customer database with said customer's point of sale system; and
storing information regarding food and beverage sales for said customer on said at least one customer database.

28. A method in accordance with claim 27, further comprising:
enabling at least one of sales forecasting, inventory management, automatic food service supplies purchasing, trend forecasting, and supplies forecast planing.

29. A method in accordance with claim 28, further comprising:
generating reports in response to a request from said customer relating to sales forecasting, inventory management, automatic food service supplies purchasing, trend forecasting, and supplies forecast planning.

30. A method in accordance with claim 27, further comprising:
integrating said at least one customer database with said customer's accounting system.

31. A method in accordance with claim 30, further comprising:
enabling at least one of vendor bill payment, vendor bill reconciliation, sales tax reporting, banking, credit card reconciliation, accounting accrual maintenance, depreciation maintenance, house charge maintenance, generation of customer statements, financial reporting, and financial analysis.

32. A method in accordance with claim 1, further comprising:
enabling said at least one supplier to provide a listing of food service supplies with associated pricing information to said supplier database.

33. A system for providing access to decision critical information for food services supply chain management, comprising:
at least one customer database for storing menu item information for one or more food services locations;
means for enabling a food services customer to access said one or more customer database and input said menu item information;
at least one supplier database, each of said at least one supplier database containing information relating to food service supplies offered by a respective supplier;
a common access portal for controlling access to said at least one customer databases and said at least one supplier database;
means for providing said customer with access to said at least one customer databases and said at least one supplier database via said common access portal;
means for enabling said customer to generate a request relating to one or more of said menu items selected from said at least one customer database; and
means for providing information to said customer from one of (i) said at least one customer database and (ii) said at least one supplier database in response to said request.
